(19) United States
(12) Patent Application Publication
(10) Pub. No.: US 2006/0121333 A1
(43) Pub. Date: Jun. 8, 2006

(54) Electrode for fuel cell, method for manufacturing the same, and fuel cell using the same

(76) Inventors: Masaya Yano, Oura-gun (JP); Atsuo Sonai, Yokohama (JP); Tae Young Kim, Seoul (KR)

Correspondence Address: MCDERMOTT WILL & EMERY LLP, 600 13TH STREET, N.W., WASHINGTON, DC, 20005-3096, US

(21) Appl. No.: 11/281,908

(22) Filed: Nov. 18, 2005

(30) Foreign Application Priority Data
Nov. 26, 2004 (JP) 2004-341824

(51) Int. Cl. H01M 4/90; H01M 4/92; H01M 4/88

(52) U.S. Cl. 429/42; 502/101

(57) ABSTRACT

Disclosed herein is an electrode for a fuel cell, comprising an ionic conductor containing a basic polymer and a strong acid, and a catalyst containing a noble metal. An example of the basic polymer includes polybenzimidazole. Examples of the strong acid include phosphoric acid and sulfuric acid. As a noble metal, platinum is preferably used. In the case where platinum is used as a catalyst, the weight of the ionic conductor is preferably 0.5 to 50% by weight with respect to the weight of the catalyst.

### BACKGROUND OF THE INVENTION

1. Field of the Invention

The present invention relates to an electrode for a fuel cell, a method for manufacturing the electrode, and a fuel cell using the electrode. More specifically, the present invention relates to an electrode and a fuel cell capable of operating under high temperatures of 100° C. or more and non-humidified conditions.

2. Description of the Related Art

A conventional polymer electrolyte fuel cell comprises a cell unit having a structure in which a cation exchanger (solid polymer) as an electrolyte membrane is provided between an air electrode and a fuel electrode. To the fuel electrode and the air electrode, pure hydrogen or a hydrogen-containing gas as a fuel and air as an oxidant gas are supplied, respectively. At the fuel electrode, the fuel reacts with water to generate protons. The protons migrate through the electrolyte membrane to the air electrode. At this time, electrons are taken out via an external circuit and are then used as electrical energy. At the air electrode, the protons from the fuel electrode react with oxygen contained in air to generate water.

As an electrode to be used for a cell unit of such a conventional polymer electrolyte fuel cell, an electrode obtained by mixing a perfluorosulfonic acid-based polymer as a cation exchanger with a platinum catalyst supported on carbon can be mentioned by way of example. However, in order to allow the cation exchanger to have proton conductivity, it is necessary for the electrolyte membrane to have sufficient moisture. Such an electrode for the conventional polymer electrolyte fuel cell is disclosed in, for example, Japanese Patent Laid-Open Publication No. Hei 5-182671.

In general, moisture required for proton conduction is supplied by adding moisture to a feed gas. Since it is necessary for the membrane to contain water in a liquid state, the operational temperature of the cell is limited to around 80° C. In addition, moisture supply requires intricate device and control. This not only makes an apparatus expensive but also makes it difficult to maintain the properties of the cell for a long period of time. Further, such a cation exchanger is likely to soften at 100° C. or higher (the glass transition point thereof as an index of ease of softening is 120 to 130° C.), and therefore it is difficult to operate the cell at high temperatures (100° C. or higher) where the properties thereof are improved.

In view of the above problems, it is an object of the present invention to provide an electrode that can be used under high temperatures of 100° C. or more and non-humidified conditions and a fuel cell using such an electrode.

### SUMMARY OF THE INVENTION

The present invention is directed to a fuel cell electrode comprising a catalyst layer including an ionic conductor containing a basic polymer and a strong acid, and a catalyst containing a noble metal.

a catalyst layer including:

Such a fuel cell electrode makes it possible to provide a fuel cell that can be used under high temperatures of 100° C. or more and non-humidified conditions, because the basic polymer and the strong acid form a complex and the complex conducts protons.

In the fuel cell electrode of the present invention, it is preferred that the ionic conductor and the catalyst be in powder form and that they be bonded using a binder.

Such a fuel cell electrode also makes it possible to provide a fuel cell that can be used under high temperatures of 100° C. or more and non-humidified conditions, because the basic polymer and the strong acid form a complex and the complex conducts protons.

Further, it is also preferred that the catalyst contain platinum. In this case, the weight of the ionic conductor with respect to the weight of the catalyst containing platinum is preferably 0.5 to 50% by weight. Further, the amount of the binder to be added is preferably 1 to 50% with respect to the weight of the catalyst containing platinum.

Furthermore, it is also preferred that the strong acid be phosphoric acid or sulfuric acid.

Moreover, it is also preferred that the basic polymer be at least one selected from the group consisting of polybenzimidazoles, poly(pyridines), poly(pyrimidines), polyimidazoles, polybenzothiazoles, polybenzoxazoles, polyoxadiazoles, polyquinolines, polyquinoxalines, polythiadiazoles, poly(tetrazapyrenes), polyoxazoles, polythiazoless, polyvinylpyridine, and polyvinylimidazoles.

Another aspect of the present invention is directed to a fuel cell comprising a cell having an anode, a cathode, and an electrolyte provided between the anode and the cathode, wherein at least one of the anode and the cathode is the fuel cell electrode described above.

Such a fuel cell can be used under high temperatures of 100° C. or more and non-humidified conditions, because the basic polymer and the strong acid constituting the fuel cell electrode form a complex and the complex conducts protons.

Still another aspect of the present invention is directed to a method for manufacturing a fuel cell electrode, comprising: adding a solvent to an ionic conductor containing a basic polymer and a strong acid to prepare a solution; mixing a catalyst containing a noble metal with the solution; and drying the solution. The manufacturing method of the present invention can further comprise pulverizing a solid product obtained by drying the solution to prepare powder and mixing the powder and a binder.

According to the manufacturing method of the present invention, it is possible to provide a fuel cell electrode for a fuel cell that can be used under high temperatures of 100° C. or more and non-humidified conditions.

### BRIEF DESCRIPTION OF THE DRAWINGS

FIG. 1 is a cross-sectional view of a fuel cell having fuel cell electrodes according to the present invention,

FIG. 2 is a graph which shows the dependence of output voltage on current (at 150° C. under non-humidified conditions) of a fuel cell using electrodes according to Example 1 and a fuel cell of Comparative Example 1,

FIG. 3 is a graph which shows the dependence of output voltage on current (at 150° C. under non-humidified conditions) of a fuel cell using electrodes according to Example 2, and

FIG. 4 is a graph which shows current-voltage curves of fuel cells using electrodes with various weight ratios between an ionic conductor (PBI-phosphoric acid) and a platinum supported catalyst.

### DETAILED DESCRIPTION OF THE INVENTION

Hereinbelow, an embodiment of the present invention will be described with reference to the appended drawings.

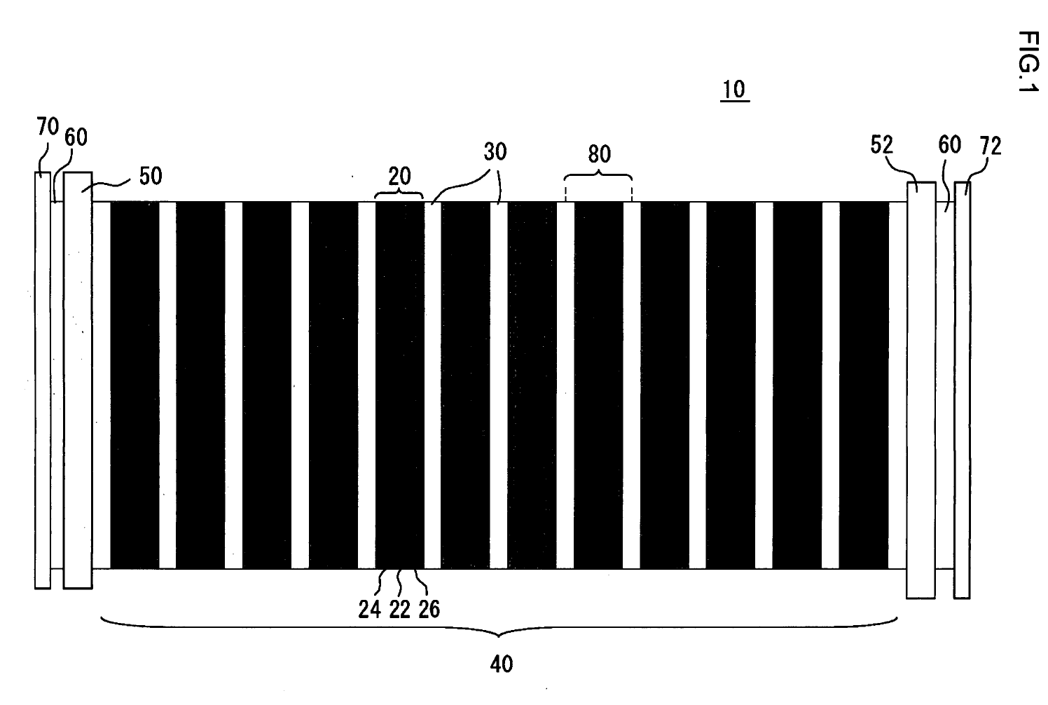

FIG. 1 is a cross-sectional view of a fuel cell having fuel cell electrodes according to the present invention (hereinafter, also referred to as “anode electrode” or “cathode electrode” when necessary; the anode electrode and the cathode electrode are sometimes collectively called “electrodes”).

A fuel cell 10 generates electric power through an electrochemical reaction by the use of hydrogen as a fuel and air as an oxidant. The fuel cell 10 includes a stack 40, negative and positive current collectors 50 and 52 provided on opposite ends of the stack 40, insulators 60, and end plates 70 and 72. The stack 40 is made up of two or more membrane electrode assemblies 20 stacked via bipolar plates 30. The end plates 70 and 72 are attached to the current collectors 50 and 52 via the insulator 60, respectively. The stack 40 is clamped by the end plates 70 and 72.

Each of the membrane electrode assemblies 20 includes a polyelectrolyte membrane 22, an anode electrode 24, and a cathode electrode 26. The anode electrode 24 is in contact with one surface of the polyelectrolyte membrane 22, and the cathode electrode 26 is in contact with the other surface of the polyelectrolyte membrane 22. The polyelectrolyte membrane 22 preferably contains a basic polymer and a strong acid such as phosphoric acid which will be described later. The anode electrode 24 and the cathode electrode 26 will be described later in detail.

Each of the bipolar plates 30 has a fuel flow channel(s) in one surface adjacent to the anode electrode 24, and has an oxidant flow channel(s) in the other surface adjacent to the cathode electrode 26. Alternatively, a fuel plate with a fuel flow channel(s), an oxidant plate with an oxidant flow channel(s), and a separator to be provided between the fuel plate and the oxidant plate may be used instead of the bipolar plate.

Each of the cells 80 mainly comprising the membrane electrode assembly 20 functions as one unit of the fuel cell. Electric power generated by each of the cells 80 is outputted to the outside through the current collectors 50 and 52.

The anode electrode 24 and the cathode electrode 26 each have a gas diffusion layer and a catalyst layer. At least one of the catalyst layers of the anode electrode 24 and the cathode electrode 26 comprises an ionic conductor containing a basic polymer and a strong acid, and a catalyst containing a noble metal.

The basic polymer is preferably at least one selected from the group consisting of polybenzimidazoles, poly(pyridines), poly(pyrimidines), polyimidazoles, polybenzothiazoles, polybenzoxazoles, polyoxadiazoles, polyquinolines, polyquinoxalines, polythiadiazoles, poly(tetrazapyrenes), polyoxazoles, polythiazoles, polyvinylpyridines, and polyvinylimidazoles. As a strong acid, phosphoric acid or sulfuric acid is preferably used. In the case where phosphoric acid is used as a strong acid, the concentration of phosphoric acid is preferably 70 to 122%. If the concentration of phosphoric acid is less than 70%, the concentration of water becomes 30% or higher so that the basic polymer cannot hold a sufficient amount of phosphoric acid. On the other hand, if the concentration of phosphoric acid exceeds 120%, phosphoric acid becomes solidified, that is, it cannot be used in the form of a solution.

The catalyst containing a noble metal is supported on a carrier such as carbon. Preferred examples of a noble metal include platinum-group noble metals such as platinum and ruthenium. Among them, platinum is more preferably used. In the case where the catalyst contains platinum, the weight of the ionic conductor is preferably 0.5 to 50% by weight. If the weight of the ionic conductor with respect to the weight of the catalyst is less than 0.5% by weight or exceeds 50% by weight, the catalytic function of the catalyst is lowered. More preferably, the weight of the ionic conductor is 10 to 25% by weight with respect to the weight of the catalyst. By setting the weight ratio of the ionic conductor to a value within the above range, it is possible to significantly improve the performance of electric power generation.

According to another embodiment of the present invention, at least one of the catalyst layers of the anode electrode 24 and the cathode electrode 26 comprises a powdered ionic conductor containing a basic polymer and a strong acid, and a powdered catalyst containing a noble metal. In this embodiment, the powdered ionic conductor and catalyst are bonded using a binder.

As a binder, a fluorine-based binder is preferably used. An example of a fluorine-based binder includes CYTOP (trade name or trademark) manufactured by Asahi Glass Co., Ltd. The amount of the binder to be added is preferably approximately 1 to 50% with respect to the weight of the catalyst containing platinum. If the weight of the binder with respect to the weight of the catalyst layer is less than 1%, binding effect of the binder cannot be sufficiently obtained. In addition, resistance is significantly increased by the catalyst layer. On the other hand, if the weight of the binder with respect to the weight of the catalyst layer exceeds 50%, the performance of the electrode is lowered.

By using such an electrode according to each of the embodiments described above for a fuel cell, the following effects can be obtained.

1) A reaction area is increased because the ionic conductor covers the particulate catalyst.

2) The fuel cell can operate under high temperatures and non-humidified conditions, because proton conductivity is ensured even in high temperatures and non-humidified conditions by using the basic polymer and the strong acid in combination. This is because the basic polymer and the strong acid form a complex and the complex conducts protons.

3) The fuel cell can operate stably for a long period of time because the amount of leakage of phosphoric acid to the outside is less. This is because the basic polymer holds phosphoric acid.

### EXAMPLE 1

A typical electrode according to the present invention was manufactured as follows. First, 12.8 g of PBI powder was added to 14 g of polyphosphoric acid (PPA: 108%) in a beaker, and then they were stirred at room temperature. To the obtained mixture, 1.7 g of 85% phosphoric acid was added. Further, 1.5 g of methanesulfonic acid (MSA) and 8.55 g of tetrafluoroacetic acid (TFA) were added thereto. The obtained mixture was stirred for about one day.

0.5307 g of the mixture thus obtained and 1.5 g of a platinum supported catalyst (Pt/C, Pt: 50 wt %) were mixed and stirred. The obtained mixture was applied on carbon paper coated with a carbon layer, and was then dried for about one hour at room temperature. It was further dried for about one hour at 150° C. in a vacuum to eliminate the remaining solvent. In this way, an electrode according to the present invention was obtained.

### EXAMPLE 2

Another typical electrode according to the present invention was manufactured as follows. First, 2.4 g of PBI powder was added to 35 g of tetrafluoroacetic acid (TFA) in a beaker, and then they were stirred for about one day at room temperature. To the obtained mixture, 0.71 g of methanesulfonic acid (MSA) was added, and then 11.32 g of 85% phosphoric acid was further added thereto little by little while stirring. The obtained mixture was stirred for about one day.

0.167 g of the mixture thus obtained and 1.5 g of a platinum supported catalyst (Pt/C, Pt: 50 wt %) were mixed and stirred. The obtained mixture was applied on a sheet made of Teflon (trademark) and dried. After drying, it was pulverized using a blender, and the obtained powder was dried all day and night at 80° C. in a vacuum.

0.700 g of the dried powder, about 0.777 g of a binder solution (9 wt %), and about 5 g of a solvent of the binder were mixed in a mortar. The obtained mixture was applied on carbon paper coated with a carbon layer and was then dried for about one hour at room temperature. It was further dried for about one hour at 150° C. in a vacuum to eliminate the remaining solvent. In this way, an electrode according to the present invention was obtained.

### COMPARATIVE EXAMPLE 1

A fuel cell (single cell) was prepared using anode and cathode electrodes containing Nafion (trademark) as an ionic conductor, and PBI-phosphoric acid as an electrolyte.

[Result of Electric Power Generation Test]

A fuel cell (single cell) was prepared using the electrodes of Example 1 as an anode and a cathode and PBI-phosphoric acid as an electrolyte, and another fuel cell (single cell) was prepared using the electrodes of Example 2 as an anode and a cathode and PBI-phosphoric acid as an electrolyte. For these fuel cells and the fuel cell of Comparative Example 1, an electric power generation test was carried out.

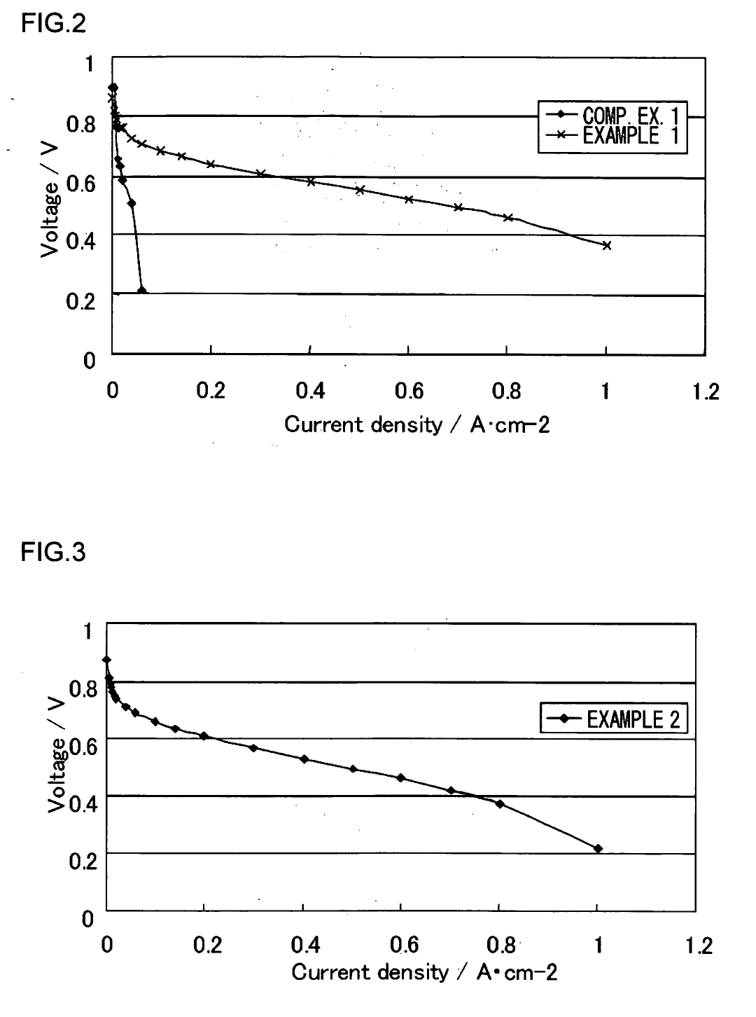

The current-voltage curves of the fuel cell using the electrodes of Example 1 and the fuel cell of Comparative Example 1 are shown in FIG. 2, and the current-voltage curve of the fuel cell using the electrodes of Example 2 is shown in FIG. 3. As shown in FIG. 2, the fuel cell using the electrodes of Example 1 outputted a voltage of 0.613 V at 150° C. under non-humidified conditions when the current density was 0.3 A/cm². Further, as shown in FIG. 3, the fuel cell using the electrodes of Example 2 outputted a voltage of 0.568 V at 150° C. under non-humidified conditions when the current density was 0.3 A/cm².

As is apparent from FIGS. 2 and 3, the fuel cell using the electrodes of Example 1 or 2 can stably output a higher voltage over a wide range of current values as compared to the fuel cell of Comparative Example 1.

[Dependence of Performance of Fuel Cell on Weight of the Ionic Conductor]

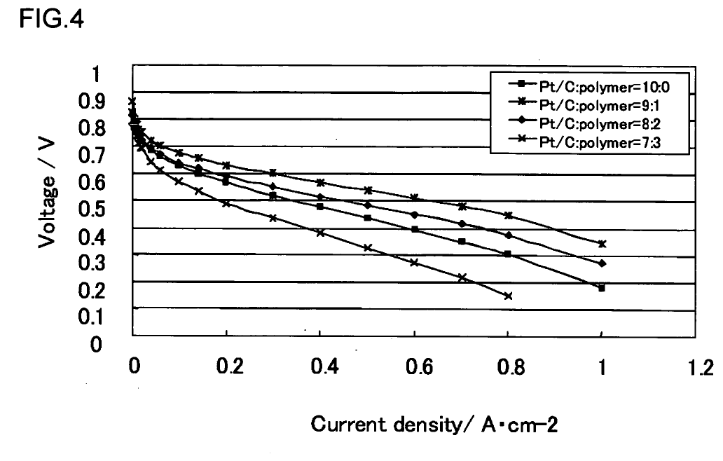

In the same manner as in Example 2, electrodes with various weight ratios between the ionic conductor (PBI-phosphoric acid) and the platinum supported catalyst were prepared. By using such electrodes as an anode and a cathode and using PBI-phosphoric acid as an electrolyte, fuel cells (single cells) were prepared, and then the performance of each of the fuel cells was evaluated. The current-voltage curves of the fuel cells with various weight ratios between the ionic conductor (PBI-phosphoric acid) and the platinum supported catalyst are shown in FIG. 4.

As is apparent from FIG. 4, in the case where the weight of the ionic conductor with respect to the weight of the catalyst was about 10% by weight (see the curve of Pt/C:polymer=9:1 in FIG. 4) and the case where the weight of the ionic conductor with respect to the weight of the catalyst was 25% by weight (see the curve of Pt/C:polymer=8:2 in FIG. 4), lowering of output voltage was suppressed even when the current was increased, thereby significantly improving the performance of electric power generation.

What is claimed is:

1. A fuel cell electrode comprising a catalyst layer including:
an ionic conductor containing a basic polymer and a strong acid; and
a catalyst containing a noble metal.

2. The fuel cell electrode according to claim 1, wherein
the ionic conductor and the catalyst are in powder form and they are bonded using a binder.

3. The fuel cell electrode according to claim 1, wherein
the catalyst contains platinum.

4. The fuel cell electrode according to claim 2, wherein
the catalyst contains platinum.

5. The fuel cell electrode according to claim 3, wherein
the weight of the ionic conductor with respect to the weight of the catalyst containing platinum is 0.5 to 50% by weight.

6. The fuel cell electrode according to claim 4, wherein
the weight of the ionic conductor with respect to the weight of the catalyst containing platinum is 0.5 to 50% by weight.

7. The fuel cell electrode according to claim 4, wherein
the amount of the binder to be added is 1 to 50% with respect to the weight of the catalyst containing platinum.

8. The fuel cell electrode according to claim 1, wherein
the strong acid is any of phosphoric acid and sulfuric acid.

9. The fuel cell electrode according to claim 2, wherein
the strong acid is any of phosphoric acid and sulfuric acid.

10. The fuel cell electrode according to claim 3, wherein
the strong acid is any of phosphoric acid and sulfuric acid.

11. The fuel cell electrode according to claim 5, wherein
the strong acid is any of phosphoric acid and sulfuric acid.

12. The fuel cell electrode according to claim 1, wherein
the basic polymer is at least one selected from the group consisting of polybenzimidazoles, poly(pyridines), poly(pyrimidines), polyimidazoles, polybenzothiazoles, polybenzoxazoles, polyoxadiazoles, polyquinolines, polyquinoxalines, polythiadiazoles, poly(tetrazapyrenes), polyoxazoles, polythiazoles, polyvinylpyridines, and polyvinylimidazoles.

13. The fuel cell electrode according to claim 2, wherein
the basic polymer is at least one selected from the group consisting of polybenzimidazoles, poly(pyridines), poly(pyrimidines), polyimidazoles, polybenzothiazoles, polybenzoxazoles, polyoxadiazoles, polyquinolines, polyquinoxalines, polythiadiazoles, poly(tetrazapyrenes), polyoxazoles, polythiazoles, polyvinylpyridine, and polyvinylimidazole.

14. The fuel cell electrode according to claim 3, wherein
the basic polymer is at least one selected from the group consisting of polybenzimidazoles, poly(pyridines), poly(pyrimidines), polyimidazoles, polybenzothiazoles, polybenzoxazoles, polyoxadiazoles, polyquinolines, polyquinoxalines, polythiadiazoles, poly(tetrazapyrenes), polyoxazoles, polythiazoles, polyvinylpyridines, and polyvinylimidazoles.

15. The fuel cell electrode according to claim 4, wherein
the basic polymer is at least one selected from the group consisting of polybenzimidazoles, poly(pyridines), poly(pyrimidines), polyimidazoles, polybenzothiazoles, polybenzoxazoles, polyoxadiazoles, polyquinolines, polyquinoxalines, polythiadiazoles, poly(tetrazapyrenes), polyoxazoles, polythiazoles, polyvinylpyridines, and polyvinylimidazoles.

16. A fuel cell comprising a cell having an anode, a cathode, and an electrolyte provided between the anode and the cathode, wherein
at least one of the anode and the cathode is the fuel cell electrode according to claim 1.

17. A fuel cell comprising a cell having an anode, a cathode, and an electrolyte provided between the anode and the cathode, wherein
at least one of the anode and the cathode is the fuel cell electrode according to claim 2.

18. A method for manufacturing a fuel cell electrode, comprising:
adding a solvent to an ionic conductor containing a basic polymer and a strong acid to prepare a solution;
mixing a catalyst containing a noble metal with the solution; and
drying the solution.

19. The method for manufacturing a fuel cell electrode according to claim 19, further comprising:
pulverizing a solid product obtained by drying the solution to prepare powder; and
mixing the powder and a binder.
